(19) United States
(12) Patent Application Publication
(10) Pub. No.: US 2006/0250940 A1
(43) Pub. Date: Nov. 9, 2006

(54) Constant broadcast channel timing in a wireless communication system

(76) Inventors: Olav Tirkkonen, Helsinki (FI); Pauli Seppinen, Espoo (FI); Mika Rinne, Espoo (FI); Gilles Charbit, Farnborough (GB)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/403,143

(22) Filed: Apr. 11, 2006

Related U.S. Application Data
(60) Provisional application No. 60/671,842, filed on Apr. 15, 2005.

(51) Int. Cl. H04J 11/00

(52) U.S. Cl. 370/208; 370/338

(57) ABSTRACT

Method by which the guard interval in use by a radio access network of a wireless communication system, such as a one using OFDM, is communicated from the radio access network to a mobile station so that the mobile station need not try different guard intervals to determine which is in use. The method is based on transmitting system information indicative of the guard interval at a predetermined time relative to a training sequence. Corresponding equipment is also provided.

### CROSS REFERENCE To RELATED APPLICATION

Reference is made to and priority claimed from U.S. provisional application Ser. No. 60/671,842, filed 15 Apr. 2005.

### BACKGROUND OF THE INVENTION

1. Technical Field

The present invention pertains to the field of wireless communication in a system where a guard interval conveying a cyclic prefix is used to alleviate inter-symbol interference.

2. Discussion of related art

The invention has to do with wireless communication systems that use a guard interval between symbols. An example is orthogonal Frequency Division Multiplexing (OFDM). One application of OFDM is as in 3.9 G or Evolved (UMTS) Universal Mobile Telecommunications System) Terrestrial Radio Access) UTRA radio interface.

In OFDM, in a wireless communication system at least, after source and channel coding, the serial input bit stream is serial-to-parallel connected to N parallel bit streams at rate 1/N, and each of the N-bit streams is then mapped to a respective series of modulation symbols (using e.g. PSK or QAM modulation), and the modulation symbols are then used to modulate a corresponding (physical) sub-channel at a frequency such that the sub-channel signal is at least pseudo-orthogonal to all the other sub-channel signals, and so to provide a set of mutually (at least pseudo-) orthogonal sub-carrier signals, each corresponding to a physical sub-channel, and each modulated by modulation symbols. (In OFDM, therefore, a set of sub-channel signals are transformed by mathematical means to modulated symbols of the carrier signal.) To mitigate inter-symbol interference (ISI) and possible other channel effects, a guard interval is used prior to each modulation symbol (at least after the training sequence), and the signal for a symbol is cyclically extended for the length of the guard interval and pre-pended to the symbol, so as to serve as a prefix to the symbol, i.e. the guard interval conveys a so-called cyclic prefix (CP).

Depending on the communication channel at the time of communication, different guard intervals (and so typically different cyclic prefix lengths) may be used. It is necessary for a receiver to know the guard interval (or cyclic prefix) in use to be able to correctly receive the symbol following the guard interval.

In a multipath channel, the channel makes echoes of the transmitted symbol. The pertinent numbers are the delay spread, and the root-mean-square (RMS) delay spread. When dimensioning cyclic prefix length in an OFDM system for downlink, it is required that the cyclic prefix be longer than the expected RMS delay spread. In larger cells, the expected RMS delay spread is larger, up to 7 μs in mountainous terrain, whereas indoors the RMS delay spread may be fractions of a microsecond. In the uplink, in addition to the delay spread, the cell range and the possible synchronicity of users have also to be taken into account.

In a given environment, an excessive cyclic prefix length (and so an excessively long guard interval) wastes resources, as cyclic prefix is a resource not used for (actually) transmitting data. A too short cyclic prefix length similarly reduces throughput, as ISI then occurs between consecutive symbols and starts to limit performance.

When designing a system that is to operate in widely differing scenarios, the cyclic prefix can be dimensioned according to the worst case scenario. The worst case cell is a very atypical cell. Thus the cyclic prefix is over-dimensioned for most cells, and resources are wasted.

In prior art (IEEE 802.16 (broadband wireless)), multiple different guard intervals/ cyclic prefixes are specified. A suitable cyclic prefix is used in a cell. When synchronizing to the cell, the UE must test the alternatives for cyclic prefix, and identify the one in use by experimentation, e.g. trial and error, testing each alternative in turn, until one is found that works.

This testing takes time. It would be advantageous to eliminate the testing.

### DISCLOSURE OF INVENTION

Accordingly, in a first aspect of the invention, an apparatus is provided, comprising: a modulator, responsive to an input bit stream, for providing for wireless transmission a modulated carrier signal comprising a plurality of sub-channels by modulating for each sub-channel a sub-carrier at a sub-carrier frequency according to a modulation scheme mapping bits to modulation symbols, at least one of the sub-channels provided by modulating a respective one of the sub-carriers by a training sequence and by system information indicative of a guard interval preceding at least payload modulation symbols conveyed by the sub-channels; wherein the modulator is configured so that for the at least one sub-carrier, the training sequence is separated from the system information by an interval of predetermined length.

The invention also provides an element of a radio access network of a wireless communication system, comprising an apparatus according to the first aspect of the invention, and further comprising a transmitter, responsive to the modulated carrier signal, for wirelessly transmitting the modulated carrier.

In a second aspect of the invention, a method is provided, comprising: providing a modulated carrier signal comprising a plurality of sub-channels, in response to an input bit stream, by modulating for each sub-channel a sub-carrier at a sub-carrier frequency according to a modulation scheme mapping bits to modulation symbols, at least one of the sub-channels provided by modulating a respective one of the sub-carriers by a training sequence and by system information indicative of a guard interval preceding at least payload modulation symbols conveyed by the sub-channels; wherein for the at least one sub-carrier, the training sequence is separated from the system information by an interval of predetermined length

The invention also provides a computer program product comprising a computer readable storage structure embodying computer program code thereon for execution by a computer processor, wherein said computer program code comprises instructions for performing a method according to the second aspect of the invention.

The invention also provides an application specific integrated circuit operative according to a method according to the second aspect of the invention.

In a third aspect of the invention, an apparatus is provided, comprising: a demodulator, responsive to a modulated carrier signal comprising a plurality of sub-channels, for demodulating at least one of the sub-channels of the modulated carrier signal to obtain modulation symbols and then bits corresponding to the modulation symbols and representing a training sequence and system information indicative of a guard interval preceding at least payload modulation symbols conveyed by the sub-channels; wherein the demodulator is configured to locate the system information based on a separation of the system information from the training sequence by an interval of predetermined length.

The invention also provides a mobile station, comprising an apparatus according to the third aspect of the invention, and further comprising a receiver, for receiving the modulated carrier signal.

In a fourth aspect of the invention, a method is provided, comprising: in response to a modulated carrier signal comprising a plurality of sub-channels, demodulating at least one of the sub-channels of the modulated carrier signal to obtain modulation symbols and then bits corresponding to the modulation symbols and representing a training sequence and system information indicative of a guard interval preceding at least payload modulation symbols conveyed by the sub-channels; wherein in demodulating the at least one of the sub-channels, the system information is located based on a separation of the system information from the training sequence by an interval of predetermined length.

The invention also provides a computer program product, comprising a computer readable storage structure embodying computer program code thereon for execution by a computer processor, wherein said computer program code comprises instructions for performing a method according to the fourth aspect of the invention.

The invention also provides an application specific integrated circuit operative according to a method according to the fourth aspect of the invention.

The invention also provides a system, comprising a radio access network including at least one element configured for communicative coupling to at least one mobile station, and the at least one mobile station, wherein either the element of the radio access network includes an apparatus according to the first aspect of the invention and/or the mobile station includes an apparatus according to the third aspect of the invention.

In a fifth aspect of the invention, a mobile device is provided for operating in a radio environment in which a base station transmits radio frames, wherein at least two different guard intervals are defined per radio frame and a training sequence symbol and subsequent system information symbol are separated by a fixed guard interval and further symbols of the frame are separated by other subsequent guard intervals with an interval equal to or less than said fixed guard interval.

In a sixth aspect of the invention, a mobile device is provided for operating in a radio environment in which a base station transmits frames, each frame including a training symbol followed in succession by a guard interval, a system information symbol, and then further symbols separated from each other by subsequent guard intervals, said mobile device comprising: a framing device, responsive to said training symbol, for determining position in time of a frame and providing a signal indication thereof; and a signal processor, responsive to said signal indication of said position in time of said frame for determining position in time of said system information symbol at a fixed guard interval after said training symbol for enabling a determination of said system information by said mobile device in order to permit said mobile device to process said further symbols separated from each other by said subsequent guard intervals with an interval equal to or less than said fixed interval.

In accord with the sixth aspect of the invention, the mobile device may also comprise a determiner, responsive to a system information signal from said signal processor, for providing a guard interval signal.

In a seventh aspect of the invention, a mobile telecommunication system is provided, comprising a radio access network including a base station for transmitting radio frames, wherein the base station is configured so that at least two different guard intervals are defined per radio frame and a training sequence symbol and subsequent system information symbol are separated by a fixed guard interval and further symbols of the frame are separated by other subsequent guard intervals with an interval equal to or less than said fixed guard interval.

In an eighth aspect of the invention, a method is provided, comprising: utilizing guard intervals for separating symbols conveying user information in wireless transmission using orthogonal frequency division multiplexing; and communicating a training sequence symbol and also a system information symbol containing information concerning said guard intervals, wherein the training sequence symbol and system information symbol are separated by an interval of predetermined length.

In a ninth aspect of the invention, an apparatus is provided, comprising: a modulator means, responsive to an input bit stream, for providing for wireless transmission a modulated carrier signal comprising a plurality of sub-channels by modulating for each sub-channel a sub-carrier at a sub-carrier frequency according to a modulation scheme mapping bits to modulation symbols, at least one of the sub-channels provided by modulating a respective one of the sub-carriers by a training sequence and by system information indicative of a guard interval preceding at least payload modulation symbols conveyed by the sub-channels; wherein the modulator means is configured so that for the at least one sub-carrier, the training sequence is separated from the system information by an interval of predetermined length.

In accord with the ninth aspect of the invention, the apparatus may further comprise means for including a value of length for the guard interval in the system information indicative of the guard interval.

In a tenth aspect of the invention, an apparatus is provided, comprising: a demodulator means, responsive to a modulated carrier signal comprising a plurality of sub-channels, for demodulating at least one of the sub-channels of the modulated carrier signal to obtain modulation symbols and then bits corresponding to the modulation symbols and representing a training sequence and system information indicative of a guard interval preceding at least payload modulation symbols conveyed by the sub-channels; wherein the demodulator means is configured to locate the system information based on a separation of the system information from the training sequence by an interval of predetermined length.

In accord with the tenth aspect of the invention, the apparatus may further comprise means for obtaining a value of length for the guard interval from the system information indicative of the guard interval.

### BRIEF DESCRIPTION OF THE DRAWINGS

The above and other objects, features and advantages of the invention will become apparent from a consideration of the subsequent detailed description presented in connection with accompanying drawings, in which:

FIG. 1 shows a packet network architecture for UMTS of a type in which the invention can be implemented.

FIG. 2 shows some further details of the overall architecture of the UMTS of FIG. 1.

FIG. 3 is a schematic illustrating an exemplary frame structure for a proposed symbol arrangement with a plurality of cyclic prefix sizes (in this case two), in which system information conveyed in thee frame indicates at least one of the cyclic prefix sizes and the other is predetermined, in accord with the invention.

FIG. 4 shows a mobile station, in accord with the invention.

FIG. 5 is block diagram/flow diagram of a base station and a mobile station in operation according to the invention.

FIG. 6 is a schematic illustrating the timing relationship between a training sequence and system information indicative of a guard interval, in accord with the invention.

### BEST MODE FOR CARRYING OUT THE INVENTION

The invention is directed to communication to a mobile station from a base station (or analogous component, such as a Node B) of a wireless communication system where a guard interval of some length separates at least some modulation symbols, in situations where the mobile station does not know the guard interval in use (because of e.g. being handed over to the base station from another base station) and so cannot demodulate the modulation symbols preceded by the guard interval (because it must know the length of the guard interval to do so). The invention assumes that information indicating the length of the guard interval (or, equivalently, the length of a cyclic prefix, as explained above, in applications where the guard interval conveys a cyclic prefix) is provided by system information included in a radio frame communicated by the base station (over e.g. a logical broadcast channel). It is further assumed that the radio frame including the system information also conveys a training sequence, typically at the beginning of the radio frame, which is used to synchronize to the base station and/or enable the mobile station to adjust its radio receiver to the dynamic conditions of the communication channel (air interface) between the mobile and the base. The same radio frame or at least other radio frames include payload symbols (conveying e.g. user data), each preceded by the guard interval of length at first unknown to the mobile station. Once the mobile determines the length of the guard interval, it can extract the payload symbols from the radio frame conveying them, and demodulate them (to obtain the one or more bits each conveyed).

The training sequence can include one or more bit sequences, typically for enabling synchronization to the base station and typically also for performing channel equalization (to adjust the receiver to the air interface differently degrading communications at different frequencies).

In accord with the invention, at least one communication frame—the frame conveying the guard interval information in system information—of at least one downlink (physical) sub-channel of a system in which a plurality of sub-channels are conveyed in parallel (such as in OFDM) includes a training sequence having a fixed time relationship to the system information, i.e. the two are separated by a time interval of predetermined length, and so known to the mobile station when it first receives a downlink signal from the base station. Thus, a mobile station knows where in the communication frame to look for the system information, and can then read the information indicating about the guard interval in use, i.e. the mobile can read the length of the guard interval in the system information. In some such embodiments, as noted above, the guard interval conveys a cyclic prefix for the modulation symbol it precedes, which is useable in mitigating ISI.

The system information may be so extensive as to be conveyed by a plurality of modulation symbols, separate from the modulation symbol (or symbols) conveying the training sequence, and if so, the time interval that is predetermined is advantageously the interval between the end of the training sequence and the beginning of the modulation symbol conveying the information about the guard interval, but at any rate, indicates the location of the system information conveying the information about the guard interval (even if that system information is conveyed by the same modulation symbol as conveys the training sequence).

Taking e.g. the case where the training sequence is conveyed first in the radio frame, by a single training sequence modulation symbol, and the system information including the length of the guard interval is conveyed by a system information symbol that occurs next, followed by one or more payload symbols, the invention allows for the possibility that all of the modulation symbols following the training sequence modulation symbol are preceded by a guard interval, but the guard interval preceding the system information modulation symbol may be different in length than the guard intervals preceding the payload modulation symbols, and so, in accord with the invention, it is possible for the radio frame to include two kinds/lengths of guard intervals, one fixed, the other dynamic (based on conditions of the communication path).

The system information for a base station (or for a sector of a base station, in sectorized cellular communication systems) is typically signaled on a broadcast channel (BCH), a logical channel conveyed as part of a radio frame (over a physical sub-channel). In addition, other pertinent information is signaled on a common channel (CCH) (another logical channel), information such as current radio parameters for a random access channel (RACH), possible downlink allocations for terminals being handed over to the cell, and paging tokens (e.g. on a logical Paging Channel (PCH)), of interest for idle mode terminals.

The invention encompasses at least any arrangement in which system information and a training sequence are signaled, and the system information indicates a guard interval—and so a cyclic prefix length, where a cyclic prefix is in use—and the system information indicative of the guard interval (as opposed to other blocks of system information) is signaled at a predetermined time relative to the training sequence, so that e.g. there is a predetermined time interval, known to the mobile station, between the end of the training sequence and the beginning of the system information. For example, the system information can occur immediately following the training sequence and can be conveyed at least in part (the part including the information indicating the guard interval/ cyclic prefix) by the same modulation symbol as conveys the training sequence, in which case the predetermined time interval is zero. Alternatively, the system information can be conveyed (at least in part, the part conveying the guard interval/ cyclic prefix information) by a modulation symbol not conveying the training sequence (or any part of a training sequence), and immediately following the training sequence (i.e. following the modulation symbol conveying the training sequence, or following the last modulation symbol conveying the training sequence if more than one modulation symbol is used to convey the training sequence), in which case the system information would be preceded by a guard interval (typically conveying a cyclic prefix), and the predetermined time interval would be the length of this guard interval (which may be and typically would be different than the guard interval preceding subsequent modulation symbols, including the payload modulation symbols, i.e. the guard interval in use by the base station). As yet another alternative, the modulation symbol conveying at least the portion of the system information indicative of the guard interval/ cyclic prefix in use by the base station (i.e. that preceding at least the payload symbols) can follow one or more payload modulation symbols.

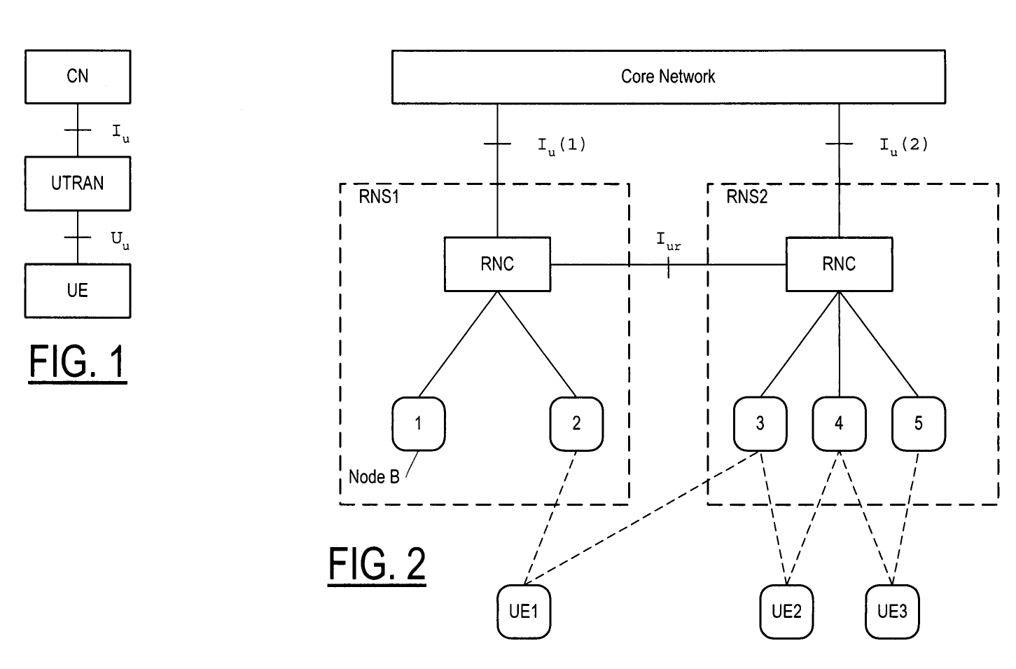

Referring to FIG. 1, the UMTS packet network architecture includes the major architectural elements of user equipment (UE), a UTRAN, and a core network (CN). The UE is interfaced to the UTRAN over a radio (Uu) interface, while the UTRAN interfaces to the core network over a (wired) Iu interface.

FIG. 2 shows some further details of the architecture, particularly the UTRAN. The UTRAN includes multiple Radio Network Subsystems (RNSs), each of which contains at least one Radio Network Controller (RNC). Each RNC may be connected to multiple Node Bs which are the 3 GPP counterparts to GSM base stations (a second generation so-called Radio Access Technology). Each Node B may be in radio contact with multiple UEs via the radio interface (Uu) shown in FIG. 1. A given UE may be in radio contact with multiple Node Bs even if one or more of the Node Bs are connected to different RNCs. For instance a UE1 in FIG. 2 may be in radio contact with Node B 2 of RNS 1 and Node B 3 of RNS 2 where Node B 2 and Node B 3 are neighboring Node Bs. The RNCs of different RNSs may be connected by an Iur interface that allows mobile UEs to stay in contact with both RNCs while traversing from a cell belonging to a Node B of one RNC to a cell belonging to a Node B of another RNC. One of the RNCs will act as the “serving” or “controlling” RNC (SRNC or CRNC) while the other will act as a “drift” RNC (DRNC). A chain of such drift RNCs can even be established to extend from a given SRNC. The multiple Node Bs will typically be neighboring Node Bs in the sense that each will be in control of neighboring cells. The mobile UEs are able to traverse the neighboring cells without having to re-establish a connection with a new Node B because either the Node Bs are connected to a same RNC or, if they are connected to different RNCs, the RNCs are connected to each other. During such movements of a UE, it is sometimes required that radio links be added and abandoned so that the UE can always maintain at least one radio link to the UTRAN. This is called soft-handover (SHO).

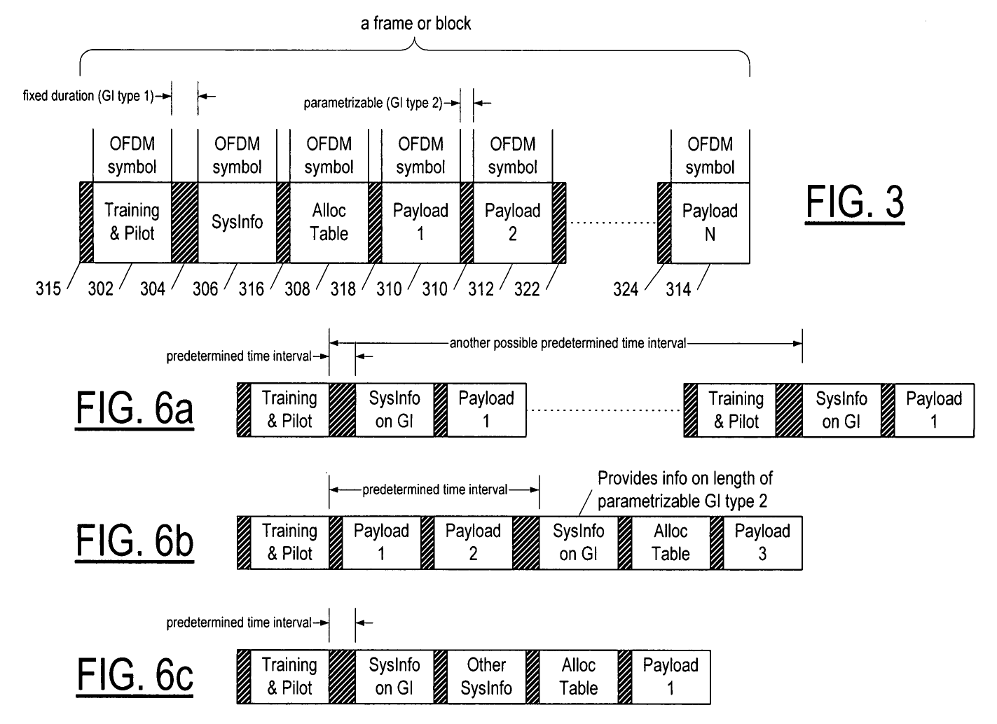

FIG. 3 shows frame structures for an exemplary proposed symbol arrangement with a plurality of cyclic prefix sizes (in this case, two), discussed below in connection with user equipment (UE), such as a mobile station/ mobile device or other equipment (e.g. a personal computer) including a “mobile terminal,” i.e. equipment for communicatively coupling to a radio access network.

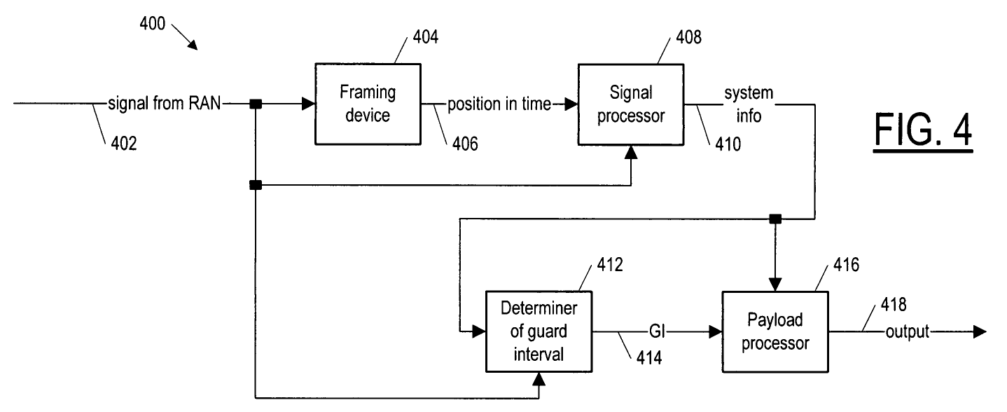

FIG. 4 shows user equipment in the form of a mobile device 400, in accord with the invention, such as one of the UEs shown in FIG. 2 for operating in a radio environment in which a base station (such as a Node B of FIG. 2) transmits frames as indicated by a signal on a line 402, each frame including a training sequence included in a training and pilot symbol 302 shown in FIG. 3, followed in succession by a guard interval 304, a system information symbol 306 indicating at least information on the guard interval 315 316 318 320 322 324 in use by the base station to prefix at least each payload symbol, and then further symbols 308 310 312 314, separated from each other by such guard intervals, having a length indicated by (at least a portion of) the system information conveyed by the system information symbol 306. The guard interval preceding the system information indicative of the guard interval in use by the base station is indicated in FIG. 3 as a type 1 guard interval, as opposed to the type 2 guard interval preceding the other symbols. The type 1 is, in this embodiment, fixed, and its length is the predetermined length indicated above in the embodiment illustrated in FIG. 3. The type 2 is variable/ parameterizable in length, depending on the channel conditions, and its length is indicated by the system information symbol 306.

As shown in FIG. 4, in accord with some embodiments of the invention the mobile device 400 comprises a framing and synchronization device 404, responsive to the training signal (corresponding to the training and pilot symbol) on the line 402, for determining position in time of a frame, and providing a signal indication thereof on a line 406. The mobile device 400 also comprises a signal processing device 408, responsive to the signal indication on the line 406 of the position in time of the frame for determining the position in time of the system information symbol 306, which occurs, in the embodiment being illustrated, immediately following the training and pilot symbol, after a fixed guard interval known to the mobile device, so that in this embodiment, the predetermined time interval is the fixed guard interval. With foreknowledge of the fixed guard interval 304, an immediate determination of the system information is enabled, without the user equipment having to conduct repeated testing of the signal on the line 402.

In accord with the invention, as noted, the system information conveyed by the system information symbol 306 includes information indicating the size of the other guard intervals/cyclic prefixes 315 316 318 320 322 324 used in the frame, i.e. those guard intervals separating the other symbols such as the payload symbols. The present invention thus permits the mobile device to process the further symbols separated from each other by a guard interval that may be the same or different from the guard interval preceding the system information symbol, and to do so after obtaining the length of the guard interval from system information (because the system information is at a predetermined location), instead of having to experiment to determine the guard interval in length.

The signal processor 408 of FIG. 4 provides system information on a line 410 to a module 412 that determines the guard interval for use in separating the other symbols. On the other hand, that information can be determined by the determiner 412 directly from the signal on the line 402 using the position in time information as determined by the framing device 404. The position in time information can be provided directly to the determiner 412 or with the system information signal on the line 410 via the signal processor 408, as shown.

In any event, once the guard interval is determined by a device such as by the module 412, it provides a signal indication thereof on a line 414 to a payload or symbol processor 416 which may also be responsive to.the system information signal on the line 410 and the signal from the radio access network on the line 402 for providing an output signal on a line 418 indicative of the symbol.

The usage of different guard intervals or cyclic prefixes, when such are conveyed by guard intervals, will now be discussed.

A shorter cyclic prefix would be used in typical cellular scenarios for typical services.

A longer cyclic prefix may be used in environments with long RMS delay spread, such as large cells and/or mountainous environments and/or certain cityscapes with a patchy skyscraper skyline. Thus, a longer cyclic prefix is advantageously always used in a cell where there is a high likelihood for long RMS delay spread. Also, a longer cyclic prefix is advantageously used in particular frames where the base station is serving (at least one) user with a particularly long delay spread, and a shorter cyclic prefix is used when all users may be served with a shorter cyclic prefix. Recall that the base station may measure the delay spread of a user from UL transmissions. The first case—where there is a high likelihood for long RMS delay spread—is simpler to realize, but the latter gives higher throughput, as the usage of the longer cyclic prefix is limited there to cases where it is needed.

A longer cyclic prefix may also be used for specific services, e.g. for multicast broadcast (MBMS). In OFDM (and other systems with cyclic prefix), signals from different base stations are combined within a large cyclic prefix, to provide seamless and transparent macro-diversity. This requires that the base stations are synchronized within the cyclic prefix used for MBMS. Regarding MBMS there are at least two situations: a) where an MBMS service is synchronously broadcast over the whole system; and b) where an MBMS service is synchronously broadcast only over part of the whole system. This latter situation may occur as a consequence of either the lack of need for a given MBMS service over the whole geographic area covered by the system, due to congestion in parts of the system, requiring delaying the MBMS service due to difficulty in arranging an absolutely synchronous MBMS transmission over the whole system, or due to limited size of effective “single frequency network” (as defined in DVB-T). (If the network is synchronous, a soft handover for download data/ shared/ dedicated channels may be realized by allocating users requiring soft handover into a frame where a longer cyclic prefix is used in both or all cells participating in the handover.)

The invention also encompasses signaling in the system information the guard interval/ cyclic prefix used in neighboring cells. This is possible as well in the above situation where particular cells would use a longer cyclic prefix for all users. In the case where an MBMS service is synchronously broadcast over the whole system, the whole system could use the longer cyclic prefix during the broadcast of a given MBMS service, so there would not be a need to signal the cyclic prefix used in a specific cell.

The (parameterizable) guard interval/ cyclic prefix in use in a cell (or in use by a base station/ node B, in case of one cell per base station/ node B) could change from cell to cell and/or from time to time at least in some situations. To convey information about the kind of users/service/handover used in a cell (and corresponding information about the guard interval/ cyclic prefix being used in the cell) to all cells in a neighborhood set, to be transmitted as part of system information, would require:

a) upper layer signalling (making the system more complex), linking the physical characteristics and/or services of users in one cell to system information transmitted in a set of other cells; and/or

b) using the cyclic prefix in a given cell for the exact period of a system information update. Typically, system information would not be updated in each frame, but with a smaller frequency. Thus, the cyclic prefix indicated would be used in subsequent frames where there is no system information update and user equipment would keep using that same cyclic prefix until a subsequent system information symbol changes the cyclic prefix in some subsequent frame. Also, periodic updates of system information pertaining to a given cell should be time aligned in all cells transmitting system information pertaining to the given cell.

Also, in an inter-system hand over (e.g. WCDMA to E-UTRAN, or from GSM to E-UTRAN), information pertaining to the cyclic prefix in use in a different system could be broadcast as a part of system information.

The invention allows reading the BCH conveying the system information without knowledge of the (parameterizable) cyclic prefix in use in a cell (or in use by a base station or Node B), and so facilitates varying the cyclic prefix to fit channel conditions without encumbering user equipment from obtaining the system information.

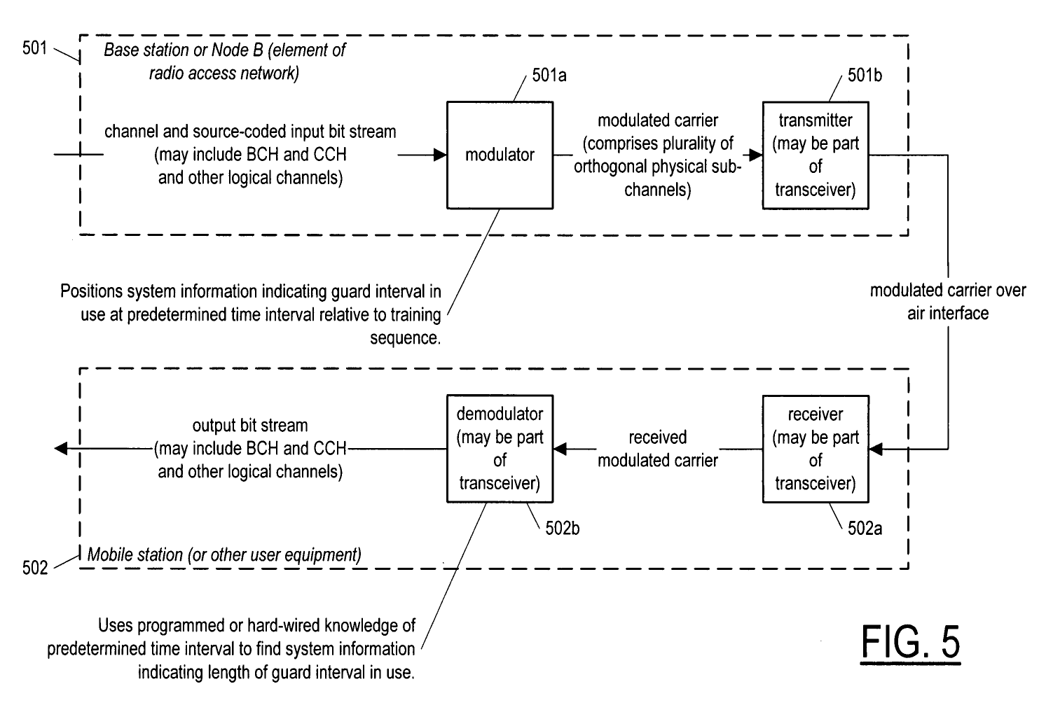

FIG. 5 shows the invention in use by a base station (or Node B) 501 (i.e. an element of a radio access network) and a mobile station 502 (or other kind of user equipment). As shown, the base station includes a modulator 501a, for modulating an input bit stream to provide a modulated carrier signal for transmission, and a transmitter 501b for transmitting the modulated carrier signal over the air. The modulated carrier signal comprises a plurality of sub-carriers, each in essence a physical sub-channel. For example, in case of OFDM, the modulated carrier consists of a plurality of orthogonal sub-carrier signals, each having been up-converted to a (higher) carrier frequency for transmission over the air interface. At least one of the these sub-carriers conveys a series of frames, and at least one of the frames includes a training sequence and the system information indicative of the (parameterizable) guard interval in use by the base station (which is provided by the logical channel BCH). In accord with the invention, the modulator provides the system information indicating the guard interval in use by the base station at a point in the frame so as to have a predetermined time interval between the system information and the training sequence (typically measured from the end of the symbol conveying the training sequence, as indicated e.g. in FIG. 3).

Still referring to FIG. 5, the mobile station 502 includes a receiver 502a for receiving the carrier signal, and a demodulator 502b which demodulates the received carrier signal to provide an output bit stream as a best guess at bit stream input to the modulator of the base station. In demodulating the received carrier signal, the demodulator uses a programmed or hard-wired (in the demodulator) value for the predetermined time interval, which allows it to locate the system information indicative of the guard interval, and then obtain the length of the guard interval in use, and so demodulate the other symbols in the frame.

FIGS. 6a, 6b and 6c illustrate various timing relationships between the training sequence (which typically enables synchronization and/or equalization) and the system information indicative of the guard interval in use by the base station (or in some wireless systems, the Node B). In FIG. 6a, as in FIG. 3, the predetermined time interval between the training sequence and the system information indicative of the guard interval in use (as opposed to possibly other system information, conveyed in other OFDM symbols) is shown in one embodiment in which it is to be interpreted by the user equipment as a positive offset (a negative offset is also encompassed by the invention), so that OFDM symbol conveying the system information is searched for by the (known) offset following the training sequence. FIG. 6a also shows the predetermined interval in an embodiment in which the predetermined time interval is such that the user equipment reads a training sequence, then waits not for the very next system information symbol, but rather the next-most system information symbol to obtain the information indicative of the guard interval in use, and then uses that information to interpret symbols previously read into a read buffer.

FIG. 6b shows a predetermined time interval such that the system information indicative of the guard interval in use follows at least some payload symbols.

FIG. 6c shows a predetermined time interval in a case where the system information is so extensive that more than one OFDM symbol are required to convey all of it, and the predetermined time interval indicates where the user equipment is to look for the particular system information symbol that conveys the information indicative of the guard interval in use.

As mentioned above, the system information symbol that conveys the information indicative of the guard interval in use could be conveyed, in some embodiments for some applications, by the same OFDM symbol that conveys the training sequence (in which case the predetermined time interval as zero length).

It should also be pointed out that although the invention is described above primarily in terms of a equipment (either a mobile or a base station/ node B) receiving or sending signals, in order to do so, the equipment must be appropriately configured or programmed or provided with appropriate application specific integrated circuits. Only with functionality provided by such special features can the equipment interpret and make use of information it receives as signals. Thus, equipment receiving a signal is indicative of the equipment processing the signal, which can be done via a general purpose processor executing instructions stored on a memory device, or by an application specific integrated circuit (ASIC) . Although an ASIC is typically digital, i.e. it is a chip designed for a particular application, in general an ASIC can be either a digital or an analog circuit. A “chip” as that term is used here denotes a small piece of semiconducting material (usually silicon) on which an integrated circuit is embedded. A typical chip can contain millions of electronic components (transistors). Thus, the invention also provides a computer program product, i.e. software stored in a non-volatile memory device in computer-readable form (e.g. on a so-called floppy disk or a so-called compact disc, as some of many examples) and indicating instructions for a computer processor, for later execution by the computer processor, once the instructions are copied into executable RAM (random access memory) used by the computer processor. And the invention also provides an ASIC, with the same functionality as provided by the processor as programmed by the software of the computer program product.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. An apparatus, comprising:
a modulator, responsive to an input bit stream, for providing for wireless transmission a modulated carrier signal comprising a plurality of sub-channels by modulating for each sub-channel a sub-carrier at a sub-carrier frequency according to a modulation scheme mapping bits to modulation symbols, at least one of the sub-channels provided by modulating a respective one of the sub-carriers by a training sequence and by system information indicative of a guard interval preceding at least payload modulation symbols conveyed by the sub-channels;
wherein the modulator is configured so that for the at least one sub-carrier, the training sequence is separated from the system information by an interval of predetermined length.

2. An apparatus as in claim 1, wherein the modulator is configured so that for the at least one sub-channel, at least some bits conveying the training sequence are mapped by the modulator into either the same or a different modulation symbol as at least some bits conveying the system information.

3. An apparatus as in claim 1, wherein the modulator is configured so that for the at least one sub-channel, all bits conveying the training sequence are mapped by the modulator into a different modulation symbol than any bits conveying the system information.

4. An apparatus as in claim 3, wherein the modulator is configured so that the interval of predetermined length is a fixed-length guard interval preceding the modulation symbol into which bits are mapped conveying the system information indicative of the guard interval.

5. An apparatus as in claim 1, wherein the modulator is configured so that for the at least one sub-channel, at least some bits conveying payload information are mapped to a modulation symbol for transmission after the training sequence and before any symbol conveying the system information.

6. An apparatus as in claim 1, wherein the modulator is configured so that the guard interval conveys a cyclic prefix to payload symbols.

7. An apparatus as in claim 1, wherein the modulator is configured so that the system information is conveyed by the same modulation symbol as the training sequence and immediately following the training sequence so that the predetermined length is zero.

8. An element of a radio access network of a wireless communication system, comprising an apparatus as in claim 1, and further comprising a transmitter, responsive to the modulated carrier signal, for wirelessly transmitting the modulated carrier.

9. A method, comprising:
providing a modulated carrier signal comprising a plurality of sub-channels, in response to an input bit stream, by modulating for each sub-channel a sub-carrier at a sub-carrier frequency according to a modulation scheme mapping bits to modulation symbols, at least one of the sub-channels provided by modulating a respective one of the sub-carriers by a training sequence and by system information indicative of a guard interval preceding at least payload modulation symbols conveyed by the sub-channels;
wherein for the at least one sub-carrier, the training sequence is separated from the system information by an interval of predetermined length

10. A method as in claim 9, wherein for the at least one sub-channel, at least some bits conveying the training sequence are mapped by the modulator into either the same or a different modulation symbol as at least some bits conveying system information.

11. A method as in claim 9, wherein for the at least one sub-channel, all bits conveying the training sequence are mapped by the modulator into a different modulation symbol than any bits conveying system information.

12. A method as in claim 11, wherein the interval of predetermined length is a fixed-length guard interval preceding the modulation symbol into which bits are mapped conveying the system information indicative of the guard interval being placed before at least payload modulation symbols during modulation.

13. A method as in claim 9, wherein for the at least one sub-channel, at least some bits conveying payload information are mapped to a modulation symbol for transmission after the training sequence and before any symbol conveying system information.

14. A method as in claim 9, wherein the guard interval conveys a cyclic prefix and is positioned before payload symbols provided by the modulator.

15. A method as in claim 9, wherein at least some of the system information is conveyed by the same modulation symbol as the training sequence and immediately following the training sequence so that the predetermined length is zero.

16. A computer program product comprising a computer readable storage structure embodying computer program code thereon for execution by a computer processor, wherein said computer program code comprises instructions for performing a method according to claim 9.

17. An apparatus, comprising:
a demodulator, responsive to a modulated carrier signal comprising a plurality of sub-channels, for demodulating at least one of the sub-channels of the modulated carrier signal to obtain modulation symbols and then bits corresponding to the modulation symbols and representing a training sequence and system information indicative of a guard interval preceding at least payload modulation symbols conveyed by the sub-channels;
wherein the demodulator is configured to locate the system information based on a separation of the system information from the training sequence by an interval of predetermined length.

18. An apparatus as in claim 17, wherein the demodulator is configured to obtain information indicating the length of the guard interval from the system information.

19. An apparatus as in claim 18, wherein the demodulator is configured to use the information indicating the length of the guard interval in demodulating payload symbols conveyed by one or another of the sub-channels.

20. A mobile station, comprising an apparatus as in claim 17, and further comprising a receiver, for receiving the modulated carrier signal.

21. A method, comprising:
in response to a modulated carrier signal comprising a plurality of sub-channels, demodulating at least one of the sub-channels of the modulated carrier signal to obtain modulation symbols and then bits corresponding to the modulation symbols and representing a training sequence and system information indicative of a guard interval preceding at least payload modulation symbols conveyed by the sub-channels;
wherein in demodulating the at least one of the sub-channels, the system information is located based on a separation of the system information from the training sequence by an interval of predetermined length.

22. A method as in claim 21, further comprising obtaining information indicating the length of the guard interval from the system information.

23. A method as in claim 22, further comprising using the information indicating the length of the guard interval in demodulating payload symbols conveyed by one or another of the sub-channels.

24. A computer program product, comprising a computer readable storage structure embodying computer program code thereon for execution by a computer processor, wherein said computer program code comprises instructions for performing a method according to claim 21.

25. A system, comprising a radio access network including at least one element configured for communicative coupling to at least one mobile station, and the at least one mobile station, wherein the element of the radio access network includes an apparatus according to claim 1.

26. A system, comprising a radio access network including at least one element configured for communicative coupling to at least one mobile station, and the at least one mobile station, wherein the mobile station includes an apparatus according to claim 1.

27. An application specific integrated circuit provided so as to operate according to a method according to claim 9.

28. An application specific integrated circuit provided so as to operate according to a method according to claim 21.

29. A mobile device for operating in a radio environment in which a base station transmits radio frames, wherein at least two different guard intervals are defined per radio frame and a training sequence symbol and subsequent system information symbol are separated by a fixed guard interval and further symbols of the frame are separated by other subsequent guard intervals with an interval equal to or less than said fixed guard interval.

30. A mobile device for operating in a radio environment in which a base station transmits frames, each frame including a training symbol followed in succession by a guard interval, a system information symbol, and then further symbols separated from each other by subsequent guard intervals, said mobile device comprising:
a framing device, responsive to said training symbol, for determining position in time of a frame and providing a signal indication thereof; and
a signal processor, responsive to said signal indication of said position in time of said frame for determining position in time of said system information symbol at a fixed guard interval after said training symbol for enabling a determination of said system information by said mobile device in order to permit said mobile device to process said further symbols separated from each other by said subsequent guard intervals with an interval equal to or less than said fixed interval.

31. The mobile device of claim 30, further comprising a determiner, responsive to a system information signal from said signal processor, for providing a guard interval signal.

32. The mobile device of claim 31, further comprising a payload processor, responsive to said guard interval signal, for processing payload at said intervals equal to or less than said fixed interval and for providing a payload output signal.

33. A mobile telecommunication system, comprising a radio access network including a base station for transmitting radio frames, wherein the base station is configured so that at least two different guard intervals are defined per radio frame and a training sequence symbol and subsequent system information symbol are separated by a fixed guard interval and further symbols of the frame are separated by other subsequent guard intervals with an interval equal to or less than said fixed guard interval.

34. A method, comprising:
utilizing guard intervals for separating symbols conveying user information in wireless transmission using orthogonal frequency division multiplexing; and
communicating a training sequence symbol and also a system information symbol containing information concerning said guard intervals, wherein the training sequence symbol and system information symbol are separated by an interval of predetermined length.

35. An apparatus, comprising:
a modulator means, responsive to an input bit stream, for providing for wireless transmission a modulated carrier signal comprising a plurality of sub-channels by modulating for each sub-channel a sub-carrier at a sub-carrier frequency according to a modulation scheme mapping bits to modulation symbols, at least one of the sub-channels provided by modulating a respective one of the sub-carriers by a training sequence and by system information indicative of a guard interval preceding at least payload modulation symbols conveyed by the sub-channels;
wherein the modulator means is configured so that for the at least one sub-carrier, the-training sequence is separated from the system information by an interval of predetermined length.

36. An apparatus as in claim 35, further comprising means for including a value of length for the guard interval in the system information indicative of the guard interval.

37. An apparatus, comprising:
a demodulator means, responsive to a modulated carrier signal comprising a plurality of sub-channels, for demodulating at least one of the sub-channels of the modulated carrier signal to obtain modulation symbols and then bits corresponding to the modulation symbols and representing a training sequence and system information indicative of a guard interval preceding at least payload modulation symbols conveyed by the sub-channels;
wherein the demodulator means is configured to locate the system information based on a separation of the system information from the training sequence by an interval of predetermined length.

38. An apparatus as in claim 37, further comprising means for obtaining a value of length for the guard interval from the system information indicative of the guard interval.
